(19) United States
(12) Patent Application Publication
(10) Pub. No.: US 2025/0286878 A1
(43) Pub. Date: Sep. 11, 2025

(54) ENROLLMENT OF SECURITY DEVICES

(71) Applicant: GENETEC INC., Saint-Laurent (CA)

(72) Inventors: Mathieu FOURNIER, Laval (CA); Philippe MAYNARD, Laval (CA); Jose MELANCON, Saint-Laurent (CA)

(21) Appl. No.: 18/930,663

(22) Filed: Oct. 29, 2024

Related U.S. Application Data
(60) Provisional application No. 63/562,018, filed on Mar. 6, 2024.

(51) Int. Cl. H04L 9/40

(52) U.S. Cl. CPC H04L 63/0815

(57) ABSTRACT

The present disclosure provides methods and systems for enrolling a security device with a surveillance system. Secret information stored by the security device is accessed. A browser-based connection to the surveillance system is launched via the security device. The browser-based connection to the surveillance system is authenticated. After authenticating the browser-based connection, the secret information is provided to the surveillance system via the browser-based connection. The surveillance system is then made to enroll the security device.

### CROSS-REFERENCE TO RELATED APPLICATIONS

This application claims priority from U.S. patent application 63/562,018 filed on Mar. 6, 2024. Its content is incorporated herewith in its entirety.

### FIELD

The present disclosure relates generally to physical security and surveillance, and more specifically to methods and systems for enrolling security devices.

### BACKGROUND

A video surveillance system may have a number of cameras connected to a server for the purpose of transmitting a data stream to the server. The server may archive the video data, manage and control the cameras, provide a workstation environment, for example, for a live view of the camera feeds, and/or provide access to camera feeds by remote workstations. Commonly, the cameras used in video surveillance systems are Internet Protocol (IP) cameras that communicate with the server over a communications network, for instance a packet-switched network.

Before the server can receive the stream data from the cameras, each of the cameras typically needs to be enrolled into the video surveillance system. That is, the server typically needs to be provided with information regarding the cameras with which it is to communicate. For example, enrolling a camera into a video surveillance system may comprise connecting the camera to a network and then manually providing the server with the IP address of the camera or using tools to facilitate the server identifying the IP address of the camera on its own, as well as establishing login credentials for the camera, among other steps.

Thus, conventional techniques for enrolling cameras into a video surveillance system may be complicated and/or cumbersome. They may require specialized expertise, be time consuming and be sensitive to human errors. When a surveillance system comprises a large number of cameras, this may translate in significant costs of installation. Other networked devices may have similar deficiencies with enrollment into a system.

Thus, improved approaches for enrolling security devices, such as surveillance cameras, are desirable.

### SUMMARY

The following presents a simplified summary of one or more implementations in accordance with aspects of the present disclosure in order to provide a basic understanding of such implementations, without limiting the embodiments presented within the present disclosure.

A surveillance system, deployed to monitor a particular location or premises, may be composed of one or more surveillance device management servers communicatively coupled with one or more surveillance devices over a communications network. The process by which a new surveillance device is coupled with a particular surveillance device management server is known as enrollment; the present disclosure describes approaches to performing enrollment of a surveillance device with a surveillance device management server. In one particular implementation, a camera is to be enrolled with a video management system (VMS), and enrollment of the camera begins by connecting to the camera using a browser to access a configuration page hosted by the camera. Accessing the configuration page causes display of a graphical-user interface (GUI) which has one or more interactive GUI elements. Upon detecting user interaction with an enrollment GUI element of the configuration page, secret information stored by the camera can be accessed and a link to a configuration site associated with the VMS is obtained. The link can be used to launch a connection to the configuration site, and once an authentication process is complete, the secret information can be provided to the VMS by way of the link. Enrollment of the camera with the VMS can then be effected using at least the secret information provided by the link, and an enrollment confirmation can be obtained from the configuration site and displayed.

In accordance with a broad aspect, there is provided a method for enrolling a security device with a surveillance system. Secret information stored by the security device is accessed. A browser-based connection to the surveillance system is launched via the security device. The browser-based connection to the surveillance system is authenticated. After authenticating the browser-based connection, the secret information is provided to the surveillance system via the browser-based connection. The surveillance system is then made to enroll the security device.

In accordance with a broad aspect, there is provided a method for enrolling a camera into a video management system (VMS) in which the camera and the VMS are connected to a common network. The method comprises: establishing a first browser-based connection over the network to the camera; accessing, over the browser-based connection, a configuration page hosted by the camera; displaying a graphical-user interface (GUI) of the configuration page, the GUI comprising at least one interactive GUI element; detecting user interaction with an enrollment GUI element of the configuration page; accessing, responsive to the detecting, secret information stored by the camera, the secret information used for enrolling the camera with the VMS; obtaining, from the configuration page in response to the user interaction, a link to a configuration site associated with the VMS, the link comprising at least part of the secret information; launching, using the link, a second browser-based connection to the configuration site; authenticating the second browser-based connection to the configuration site; after the authenticating, providing, by the link, the at least part of the secret information to the VMS via the second browser-based connection; causing the VMS to enroll the camera using the at least part of the secret information comprised in the link; and displaying an enrollment confirmation obtained from the configuration site over the second browser-based connection in response to the camera being enrolled with the VMS.

In at least some embodiments according to any one or more of the previous embodiments, said establishing of the first browser-based connection comprises connecting to the camera via an IP address associated therewith.

In at least some embodiments according to any one or more of the previous embodiments, the method comprises authenticating the first browser-based connection to the camera by supplying access credentials to the camera.

In at least some embodiments according to any one or more of the previous embodiments, said authenticating of the first browser-based connection to the camera comprises supplying default access credentials, the method comprising modifying the camera to accept a future browser-based connection using updated access credentials, different from the default access credentials.

In at least some embodiments according to any one or more of the previous embodiments, said authenticating of the second browser-based connection to the configuration site comprises supplying the access credentials to the configuration site and/or to the VMS.

In at least some embodiments according to any one or more of the previous embodiments, said launching of the second browser-based connection to the VMS comprises launching the second browser-based connection over the Internet.

In at least some embodiments according to any one or more of the previous embodiments, said authenticating of the second browser-based connection to the VMS comprises authenticating a user via a single sign-on (SSO) process.

In at least some embodiments according to any one or more of the previous embodiments, launching the second browser-based connection comprises selecting, on the configuration site associated with the VMS, one of a plurality of surveillance systems.

In at least some embodiments according to any one or more of the previous embodiments, the method comprises, after the authenticating, providing additional information for use in at least one of enrollment of the camera and configuration of the camera subsequent to enrollment thereof to the VMS via the configuration site.

In at least some embodiments according to any one or more of the previous embodiments, said providing of the additional information for the camera to the VMS comprises detecting further user interaction with the configuration site and providing, based on the further user interaction, the additional information.

In at least some embodiments according to any one or more of the previous embodiments, said accessing, responsive to the detecting, comprises accessing the additional information stored by the camera.

In at least some embodiments according to any one or more of the previous embodiments, said providing of the additional configuration information for the camera to the VMS comprises providing, by the link, the additional configuration information.

In at least some embodiments according to any one or more of the previous embodiments, said providing, by the link, of the at least part of the secret information to the VMS comprises providing the secret information in a trailing portion of the link used to launch the browser-based connection.

In at least some embodiments according to any one or more of the previous embodiments, enrollment of the camera is effected based on the user interaction with the enrollment GUI element without any additional user input.

In accordance with another broad aspect, there is provided a system for enrolling a camera into a video management system (VMS) in which the camera and the VMS being connected to a common network. The system comprises a processor; and a non-transitory computer-readable storage medium comprising instructions. The instructions are executable by the processor for causing the system to perform: establishing a first browser-based connection over the network to the camera; accessing, over the browser-based connection, a configuration page hosted by the camera; displaying a graphical-user interface (GUI) of the configuration page, the GUI comprising at least one interactive GUI element; detecting user interaction with an enrollment GUI element of the configuration page; accessing, responsive to the detecting, secret information stored by the camera, the secret information used for enrolling the camera with the VMS; obtaining, from the configuration page in response to the user interaction, a link to a configuration site associated with the VMS, the link comprising at least part of the secret information; launching, using the link, a second browser-based connection to the configuration site; authenticating the second browser-based connection to the configuration site; after the authenticating, providing, by the link, the at least part of the secret information to the VMS via the second browser-based connection; causing the VMS to enroll the camera using the at least part of the secret information comprised in the link; and displaying an enrollment confirmation obtained from the configuration site over the second browser-based connection in response to the camera being enrolled with the VMS.

In at least some embodiments according to any one or more of the previous embodiments, after the authenticating, the instructions are executable for providing additional information for use in at least one of enrollment of the camera and configuration of the camera subsequent to enrollment thereof to the VMS via the configuration site.

In at least some embodiments according to any one or more of the previous embodiments, said providing of the additional information for the camera to the VMS comprises detecting further user interaction with the configuration site and providing, based on the further user interaction, the additional information.

In at least some embodiments according to any one or more of the previous embodiments, said accessing, responsive to the detecting, comprises accessing the additional information stored by the camera.

In at least some embodiments according to any one or more of the previous embodiments, said providing of the additional configuration information for the camera to the VMS comprises providing, by the link, the additional configuration information.

In at least some embodiments according to any one or more of the previous embodiments, said providing, by the link, of the at least part of the secret information to the VMS comprises providing the secret information in a trailing portion of the link used to launch the browser-based connection.

In accordance with a further broad aspect, there is provided a method for enrolling a security device into a surveillance system. The method comprises: obtaining secret information stored by the security device; instantiating, via the security device, a browser-based connection to the surveillance system; authenticating the browser-based connection to the surveillance system; after the authenticating, providing the secret information to the surveillance system via the browser-based connection; and causing the surveillance system to enroll the security device.

### BRIEF DESCRIPTION OF THE DRAWINGS

For a more complete understanding of the present disclosure, reference is now made to the accompanying drawings. The following brief descriptions of the drawings should not be considered limiting in any fashion.

FIG. 1 is a block diagram of an example surveillance environment suitable for enrolling a security device.

FIG. 2 is an example configuration page of the security device of FIG. 1.

FIGS. 3A-D illustrate an example browser-based configuration flow for the security device of FIG. 1.

FIG. 4 is a block diagram of an example computing system.

FIG. 5 is a flowchart illustrating an example method for enrolling a security device with a surveillance system.

FIG. 6 is a flowchart illustrating another example method for enrolling a security device with a surveillance system.

It will be noted that throughout the appended drawings that like features are identified by like reference numerals.

### DETAILED DESCRIPTION

In order for a security device to communicate with other elements of the surveillance system, for instance a video management system, an access control system, or the like, the security device must be enrolled (or “configured”) in the surveillance system. The present disclosure relates to, inter alia, methods, systems, devices, and computer-readable media for enrolling security devices, such as surveillance cameras, in a surveillance system. Throughout the present discussion, reference will be made to surveillance cameras, or simply to cameras: it should be understood that the term “camera” may refer to surveillance cameras as well as to other types of cameras. In addition, although the present disclosure describes primarily embodiments relating to the enrollment of cameras, it should be understood that variants of these embodiments in which other types of security devices may be enrolled are also considered, for instance by following similar procedures and principles adapted for the other types of security devices.

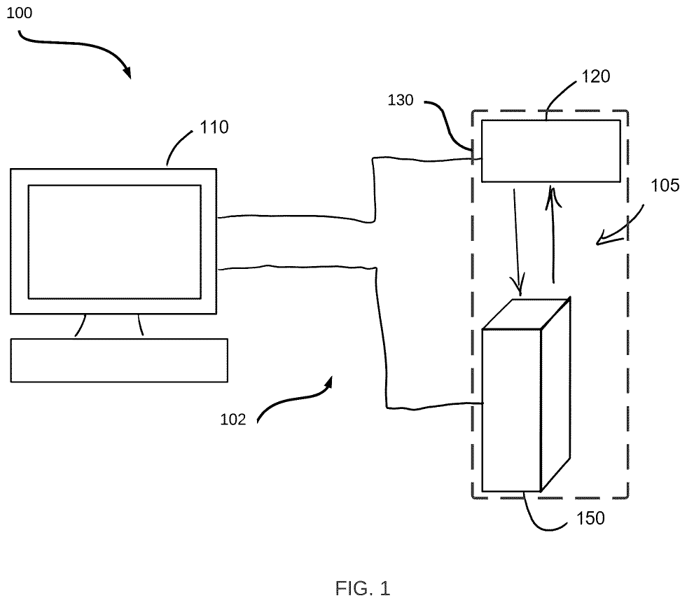

With reference to FIG. 1, a surveillance environment 100 is illustrated as including a computing device 110, a security device 120, and a security device management server 150. The computing device 110 may be any suitable type of computing device, including a laptop computer, a desktop computer, a smartphone or other mobile computing device, and the like. The computing device 110, the security device 120, and the security device management server 150 may be communicatively coupled via a network 102 over which communications may be exchanged. The network 102 may span one or more internal networks (e.g., an Intranet), one or more public networks (e.g., the Internet), and/or one or more other networks, as appropriate. In one example embodiment, the security device 120 is a camera, and the security device management server 150 is, or forms part of, a video management system (VMS). Certain elements of the surveillance environment 100 may together form a surveillance system 130: for instance, the surveillance system 130 may be composed of the security device management server 150, one or more additional security device management servers, and one or more surveillance devices, like the security device 120, that have been enrolled in the surveillance system 130. In some cases, the computing device 110 may also form part of the surveillance system 130, though in the illustrated embodiment of FIG. 1, it does not.

However, in the example illustrated in FIG. 1, the security device 120 is not yet enrolled in the surveillance system 130. Once the security device 120 is enrolled, this will allow the security device 120 and the security device management server 150 to establish a secure connection 105 over which the security device 120 and the security device management server 150 can exchange information. In some embodiments, the security device 120 may provide surveillance data to the security device management server 150 over the secure connection 105, for instance surveillance data relating to objects and/or persons observed by the security device 120. In addition, the security device management server 150 may provide instructions and configuration data to the security device 120 over the secure connection 105. In the following disclosure, various approaches for effecting enrollment of security devices, such as the security device 120, will be described.

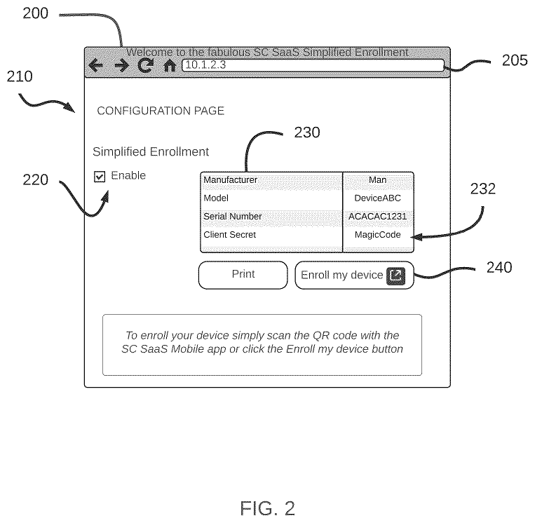

With reference to FIG. 2, in some embodiments, the security device 120 may store information for hosting a configuration page 210 which may be accessible by the computing device 110, for instance via a browser 200 or similar program. For example, the security device 120 may include a processing unit, a memory, one or more interfaces, and any other suitable components, described in greater detail hereinbelow. The configuration page 210 may be stored in the memory of the security device 120, and when the security device 120 receives a connection request via one of its interfaces from the computing device 110, the processing unit within the security device 120 may access the configuration page 210 and/or other relevant data relating thereto within the memory and provide access to the configuration page 210 to the computing device 110.

The computing device 110 may access the configuration page in any suitable fashion. For example, the configuration page 210 may be accessible by entering the IP address, the host name, or a similar identifier of the security device 120 into the address bar 205 of the browser 200. In some embodiments, the configuration page 210 may be constructed as a webpage, for instance using HTML, CSS, or the like. In the embodiment illustrated in FIG. 2, the configuration page 210 includes a logo and a title, a configuration toggle 220, an information pane 230, various links, including an enrollment button 240, and other information for presentation to a user of the computing device 110 who accesses the configuration page 210. In other embodiments, the configuration page 210 may include fewer elements, additional elements, different combinations of elements, or the like, as appropriate.

The configuration toggle 220 may serve to facilitate control of various functionality of the security device 120 from within the configuration page 210. For example, in embodiments in which the security device 120 includes various wired and/or wireless communication functionality (e.g., RFID, NFC, Bluetooth®, or the like), actuation of the configuration toggle 220 may cause one or more of the communication functionality of the security device 120 to be activated or deactivated, depending on the state of the configuration toggle 220. By way of another example, the configuration toggle may serve to control whether the security device 120 attempts to communicate with other device(s) of the surveillance environment 100 and/or other devices accessible over the wider network 102 (e.g., over the Internet). In some other embodiments, while the security device 120 is unenrolled, one or more of the communication functionality may be disabled, or the security device 120 may not attempt to communicate with other device(s), except when the configuration page 210 is accessed. In this fashion, when the configuration communication functionality to be enabled and/or enable communication with other device(s), which may be a prerequisite for proper enrollment of the device. For example, in order for the security device management server 150 to enroll the security device 120, the security device 120 may need to initiate an announcement process, by which it signals its presence on the network 102 of the surveillance environment 100. The security device 120 may therefore not perform this announcement until the configuration page 210 is accessed and/or until the configuration toggle 220 is enabled, as illustrated in FIG. 2.

The information pane 230 may present various information relating to the security device 120: in the embodiment illustrated in FIG. 2, the information pane 230 lists the manufacturer, the model number, and the serial number of the security device 120. Additionally, the information pane 230 includes secret information 232 stored within the security device 120. In the illustrated embodiment of FIG. 2, the secret information 232 is a “Client Secret” with the value “MagicCode”. In other embodiments, the secret information 232 may be any suitable type of string, number, or the like which may be kept secret by the security device 120 until made available to a user by accessing the configuration page 210. For example, the secret information 232 may be a hardcoded value assigned to the security device 120 during manufacturing or initialization. By way of another example, the secret information 232 may be a configurable value which may be altered by a user, for instance via the configuration page 210. By way of a further example, the secret information 232 may be a random or pseudo-random value generated by the security device 120, for instance every time the configuration page 210 is accessed, in response to a user request to regenerate the secret information 232 (e.g., as part of a factory reset of the security device 120), or the like. Other approaches are also considered.

The enrollment button 240 is an interactive element of the configuration page 210 which allows a user to initiate enrollment of the security device 120 from the configuration page 210. When a user interacts with the enrollment button 240, the browser 200 obtains a link, for instance in the form of a uniform resource locator (URL) associated with the enrollment button 240 and initiates a connection via the browser 200 to a remote system which operates a webpage or other resource accessible at the URL. In the case of the enrollment button 240, the URL directs the browser to initiate a connection to the security device management server 150, or another element of the surveillance system 130 of which the security device management server 150 forms part, to initiate an enrollment process for the security device 120.

To enable the enrollment of the security device 120, the URL obtained via the enrollment button 240 encodes therein enrollment information. The enrollment information can include part or all of the information in the information pane 230, and includes the secret information 232, in part or in whole. In some cases, the URL may also encode additional information, as appropriate. In this fashion, the browser 200 can, via the URL used to initiate the enrollment process with the security device management server 150, transfer to the security device management server 150 the enrollment information, which is accessible only via the security device 120 and which is presented in the configuration page 210. For example, for an enrollment service operated by the security device management server 150 that is accessible via the URL https://config.mysecuritysystem/com/simplifyenrollment, the URL obtained via the enrollment button 240 may append to the URL for the enrollment service the serial number and the client secret of the security device 120 (though other enrollment information may also be appended, as appropriate). In this example, the URL obtained via the enrollment button 240, which encodes the enrollment information and which is provided to the browser 200 to access the enrollment service, may be https://config.mysecuritysystem.com/simplifyenrollment?sn=ACACAC1231&secret=MagicCode, in which the serial number is included after the indicator “sn”, and the secret information 232 (in the form of a client secret) is appended after the indicator “secret”. Other approaches for embedding enrollment information in the URL obtained via the enrollment button 240 are also considered. For instance, rather than encoding the enrollment information in the URL in plain text, the enrollment information may be encrypted or otherwise secured, to prevent man-in-the-middle attacks or the like from obtaining, inter alia, the secret information 232.

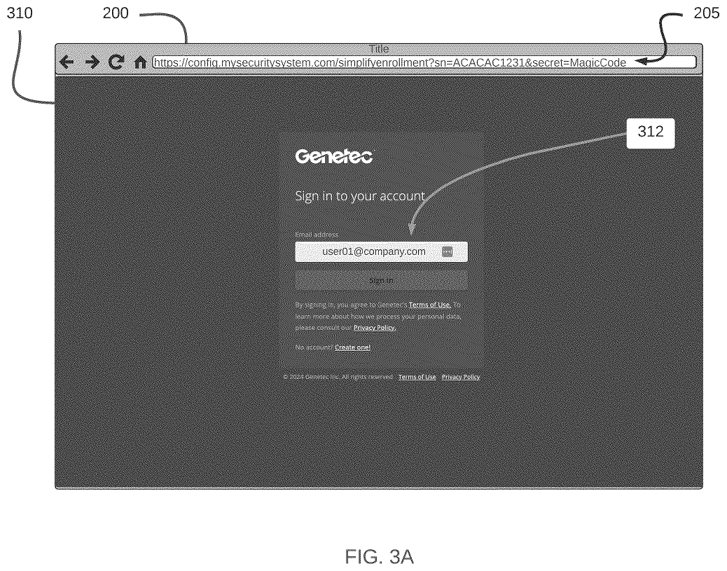

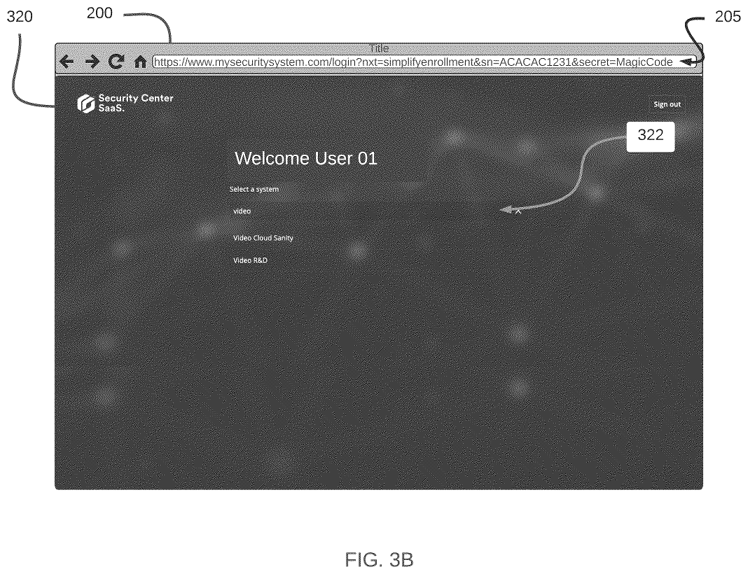

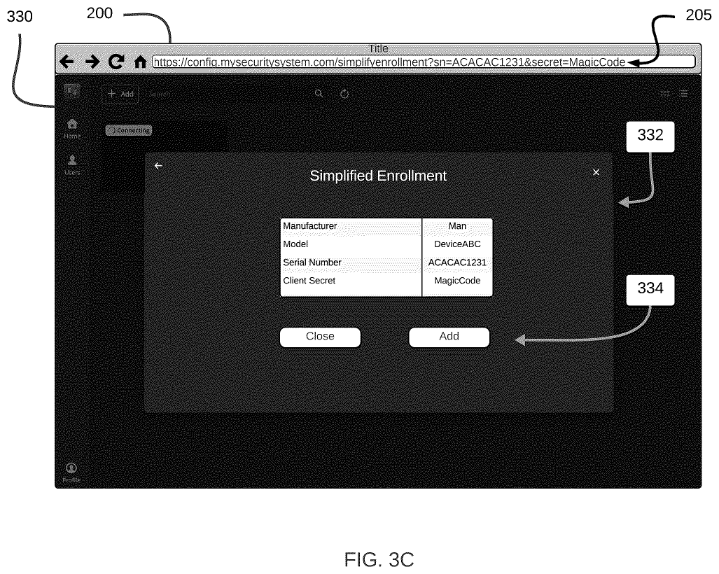

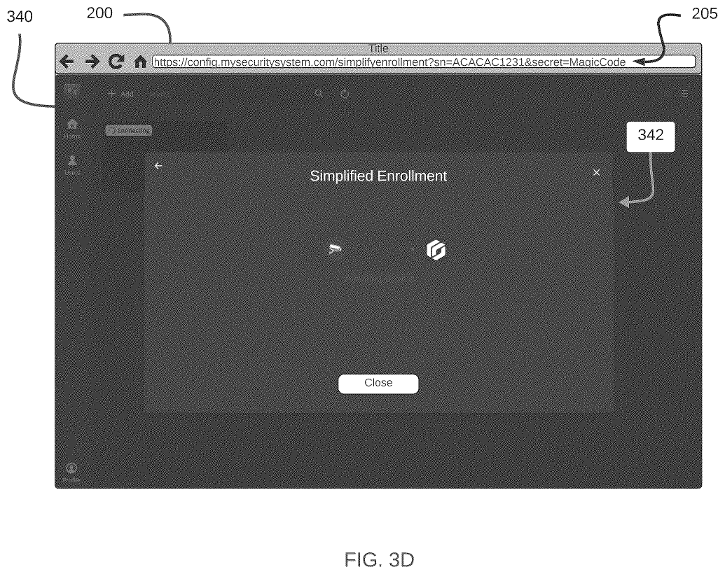

Accessing the URL associated with the enrollment button 240 causes the browser 200 to attempt to access the enrollment service, which may be a webpage operated, hosted, or otherwise accessible via the security device management server 150 and via which the security device 120 can be enrolled. In some circumstances, the user or the computing device 110 may already be authenticated with the security device management server 150, and so the request to access the enrollment service may be authenticated as a matter of course. In such circumstances, the browser 200 may proceed to the page illustrated in FIG. 3B, described in greater detail hereinbelow.

With reference to FIG. 3A, in some other circumstances, the user or the computing device 110 may not already be authenticated with the security device management server 150. In such circumstances, the request to access the enrollment service may be intercepted and the browser 200 may be redirected to a login page 310, which will request login credentials 312 from the user. The user may then provide login credentials 312 to the login page 310 via any suitable input device. To maintain the information relating to the security device 120, the URL present in the address bar 205 may continue to encode therein the enrollment information, including the secret information 232. Once authenticated, or when already previously authenticated, the browser 200 accesses the enrollment service via the aforementioned URL, which encodes therein the enrollment information, including the secret information 232.

With additional reference to FIG. 3B, in some cases, prior to accessing the enrollment service, the user may be directed to a tenant selection page 320 via which the user, operating the computing device 110, can select one of a plurality of tenants (i.e., surveillance environments 100) into which the security device 120 is to be enrolled. In the illustrated example of FIG. 3B, the configuration options 322 include a selection of a surveillance system 130 in which the security device 120 is to be enrolled, selectable via a dropdown menu (which could include the surveillance system 130). The listing of selectable surveillance environments 100 may depend on the credentials supplied by the user, whether at the login page 310 or via some other authentication process. As a result of being directed to the tenant selection page 320, the URL indicated in the address bar 205 may change, but the enrollment information continues to be encoded therein. In situations in which the user does not have access to multiple surveillance environments 100 (i.e., the user's credentials are not authorized to access different surveillance environments 100), the user may not be directed to the tenant selection page 320 and instead may be directed to the enrollment service, as described herein.

With additional reference to FIG. 3C, once the configuration options 322 are selected, the browser may be directed to an enrollment page 330, provided by the enrollment service, whether via the aforementioned URL (e.g., provided by the enrollment button 240), or via a different URL (e.g., one provided as a redirect from the tenant selection page 320). In some embodiments, by accessing the enrollment page 330, the enrollment information may be extracted from the URL and in turn provided to the security device management server 150 or other entity of the surveillance system 130, as appropriate so that the enrollment information can be used to enroll the security device 120. In some cases, the enrollment information may also be stored in a database or the like, for instance for auditability purposes. In some other embodiments, the URL used to access the enrollment page 330, which is indicated in the address bar 205, continues to encode therein the enrollment information.

The enrollment page 330 presents an enrollment pane 332 to the user, which lists various enrollment information which are used by the security device management server 150 to enroll the security device 120. In some embodiments, the information presented in the enrollment pane 332 includes only information obtained by the security device management server 150 from the URL used to access the login page 310, the tenant selection page 320, and/or the enrollment page 330. In some other embodiments, the information presented in the enrollment pane 332 includes additional information, which may be obtained by the security device management server 150 from communications with the security device 120 itself, from other devices within the surveillance system 130, or which may be derived based on the enrollment information encoded in the URL. For example, it may be possible to derive the manufacturer and/or the model of the security device 120 from the serial number, for instance in cases where different manufacturers use differently formatted serial numbers for different types of devices. The enrollment pane 332 presents the enrollment information to the user of the computing device 110 to allow the user to confirm that the enrollment information is correct prior to enrollment of the security device 120. The enrollment page 330 can present various interactive elements 334 to receive input confirming or refusing the enrollment of the security device 120, based on the user's evaluation of the enrollment information.

With additional reference to FIG. 3D, when the user confirms the enrollment of the security device 120 via the appropriate interactive element 334, the browser 200 may display an enrollment progress page 340, in which an enrollment progress pane 342 is displayed. The enrollment progress pane 342 serves to display information about the progress of the enrollment process for the security device 120: as different steps in the enrollment process are completed, the user may be notified by displaying information within the enrollment progress pane 342. Additionally, if any errors occur during the enrollment process, the user may be notified of the errors via the enrollment progress pane 342. Once enrollment of the security device 120 completes, the enrollment progress pane 342 may display a confirmation message. The user may then close or otherwise exit the enrollment progress page 340.

In some embodiments, the enrollment process may skip the enrollment page 330 entirely and instead progress directly from either the login page 310 and/or the tenant selection page 320 to the enrollment progress page 340. Additionally, in cases in which the user is not associated with multiple tenants and in which the user is already logged in, interacting with the enrollment button 240 to obtain the URL used by the browser to access the enrollment service may result in the enrollment service directly loading the enrollment progress page 340. This approach may substantially reduce the amount of time and user input required to effect enrollment of the security device 120.

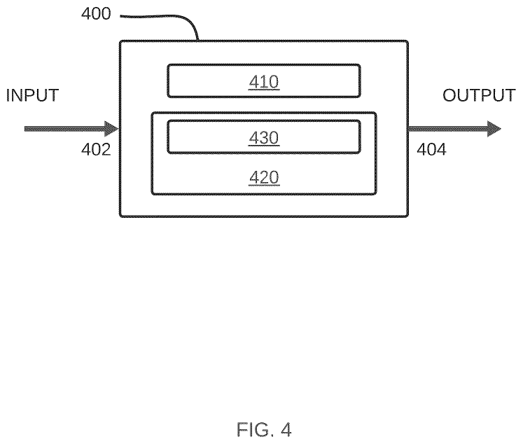

With reference to FIG. 4, there is illustrated a schematic diagram of an example computing device 400. As depicted, the computing device 400 includes at least one processor 410, a memory 420, and program instructions 430 stored within the memory 420, as well as input and output interfaces (I/O interfaces) 402 and 404, respectively. For simplicity, only one computing device 400 is shown; the various computing devices described herein may be embodied by one or more implementations of the computing device 400, which may be the same or different types of devices. For instance, the computing device 110, the security device 120, the security device management server 150, and/or any other device described herein may be implemented by one or more computing devices 400. The components of the computing device 400 may be connected in various ways including directly coupled, indirectly coupled via a network (e.g., part or all of the networks described herein), and distributed over a wide geographic area and connected via a network, for instance via a cloud computing implementation.

The I/O interfaces 402, 404 may include one or more media interfaces, via which removable media or other data sources may be coupled, one or more network interfaces, or any other suitable type of interface. The I/O interfaces 402, 404 of the computing device 400 may additionally, in some embodiments, provide interconnection functionality to one or more input devices, such as a keyboard, mouse, camera, touch screen and a microphone, or with one or more output devices such as a display screen and a speaker, for instance devices via which a user may interact with a server. In embodiments in which the I/O interfaces 402, 404 include one or more network interfaces, the network interface(s) of the computing device 400 may enable the computing device 400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

The processor 410 may be, for example, any type of general-purpose microprocessor or microcontroller, a digital signal processing (DSP) processor, an integrated circuit, a field programmable gate array (FPGA), a reconfigurable processor, a programmable read-only memory (PROM), or any combination thereof. The processor 410 may be configured for executing the instructions 430 stored within the memory 420. The memory 420 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically erasable programmable read-only memory (EEPROM), Ferroelectric RAM (FRAM) or the like.

In certain embodiments, the computing device 400 is operable to register and authenticate users (using a login, unique identifier, and password for example) prior to providing access to applications, a local network, network resources, other networks, and network security devices (one or more of which may form part of the network(s) described herein). The computing device 400 may serve one user or multiple users.

For example, and without limitation, the computing device 400 may be a server, network appliance, set-top box, embedded device, computer expansion module, personal computer, laptop, personal data assistant, cellular telephone, smartphone device, UMPC tablets, video display terminal, gaming console, electronic reading device, and wireless hypermedia device or any other computing device capable of being configured to carry out the methods and/or implementing the systems described herein.

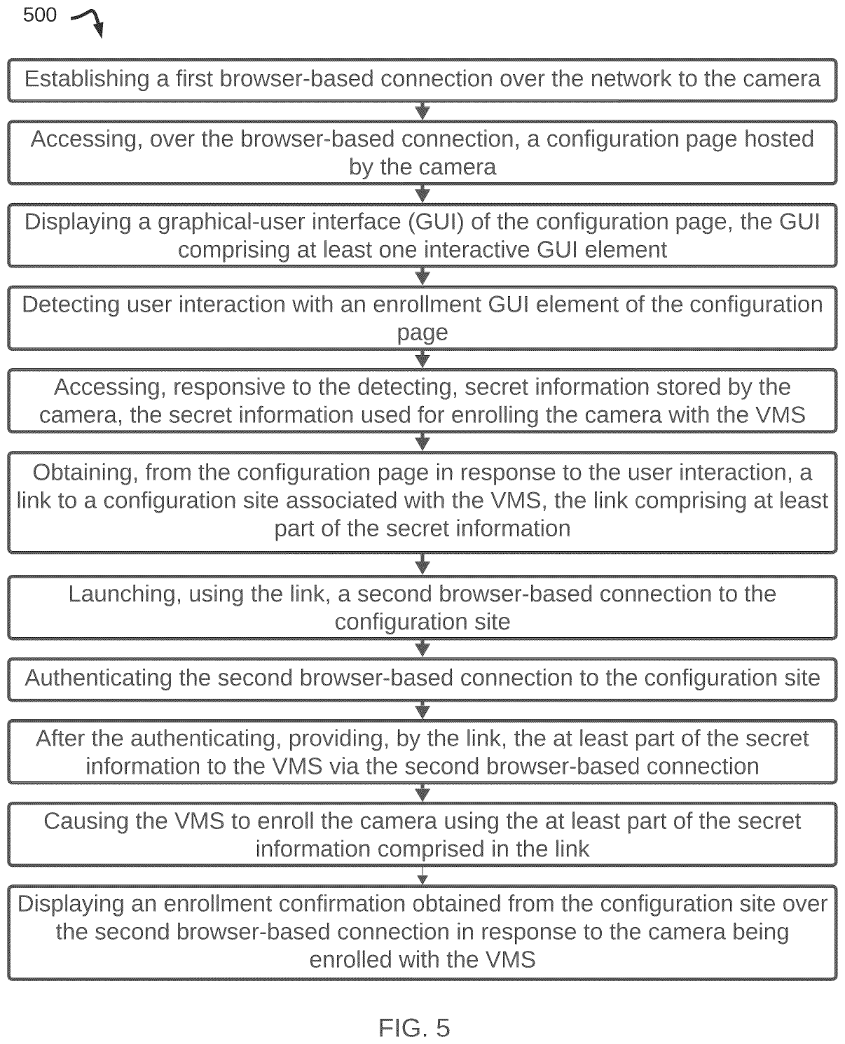

With reference to FIG. 5, there is illustrated a method 500 for enrolling a camera (e.g., the security device 120) with a video management system (e.g., with the security device management server 150 of the surveillance system 130), in which the camera and the VMS are connected to a common network (e.g., the network 102 of the surveillance environment 100). The method may be performed, for example, at the computing device 110.

A first browser-based connection is established to the camera over the network, for instance the network 102 of the surveillance environment 100. A configuration page hosted by the camera, for instance the configuration page 210, is accessed over the browser-based connection. The configuration page 210 may be rendered in a browser, for instance the browser 200. The configuration page 210 may cause the computing device 110 to display, via the browser 200, a GUI of the configuration page 210 which includes at least one interactive GUI element, for example including the enrollment button 240.

User interaction with an enrollment GUI element of the configuration page 210, for instance the enrollment button 240, can be detected. In response to detecting user interaction with the enrollment button 240, secret information stored by the camera, for instance at least part of the secret information 232, is accessed. The secret information 232 can be used to facilitate or enable enrollment of the camera with the VMS. In some embodiments, user interaction with the enrollment button 240 also causes additional information to be accessed, for instance including part or all of the information in the information pane 230. In some embodiments, obtaining the at least part of the secret information 232 and, in some cases, the additional information comprises obtaining a URL for a configuration site hosted by the VMS, or by another entity related thereto, as will be described hereinbelow.

A link to a configuration site, for instance one or more of the login page 310, the tenant selection page 320, the enrollment page 330 and/or the enrollment progress page 340, is obtained from the configuration page 210 in response to the user interaction. As described hereinabove, the link may be a URL which comprises the at least part of the secret information 232. In some cases, the link may be a URL which includes additional information, for instance part or all of the information present in the information pane 230. The pages 310-340 may be hosted by the VMS or by an entity related thereto, as appropriate. Then, a second browser-based connection may be launched, using the link, to the configuration site, which may be to any one (or more) of the pages 310-340.

The second browser-based connection to the configuration site is authenticated. In some cases, the browser itself, or a user thereof, may already be authenticated. In some other cases, the configuration site may request authentication from the user, for instance via the login page 310. After the authenticating, the at least part of the secret information 232 is provided to the VMS by the link and via the second browser-based connection. By using the link to access the configuration site, the VMS may extract the at least part of the secret information 232 from the URL to facilitate or enable the enrollment of the camera.

The VMS is then caused to enroll the camera using the at least part of the secret information 232 that is contained in the link. This may involve storing information relating to the camera within the VMS and/or establishing a secure connection, for instance the secure connection 105, with the camera on the basis of the secret information. For example, the at least part of the secret information 232 may be used as part of an exchange of encrypted messages with the camera. Then, in response to the camera being enrolled with the VMS, an enrollment confirmation is displayed. The enrollment confirmation may be obtained from the configuration site over the second browser-based connection, for instance from the enrollment progress page 340, and may be displayed on the computing device 110 in any suitable fashion. For example, the enrollment confirmation may include a visible portion, such as a confirmation message, and an audible portion, such as a musical tone or other sound.

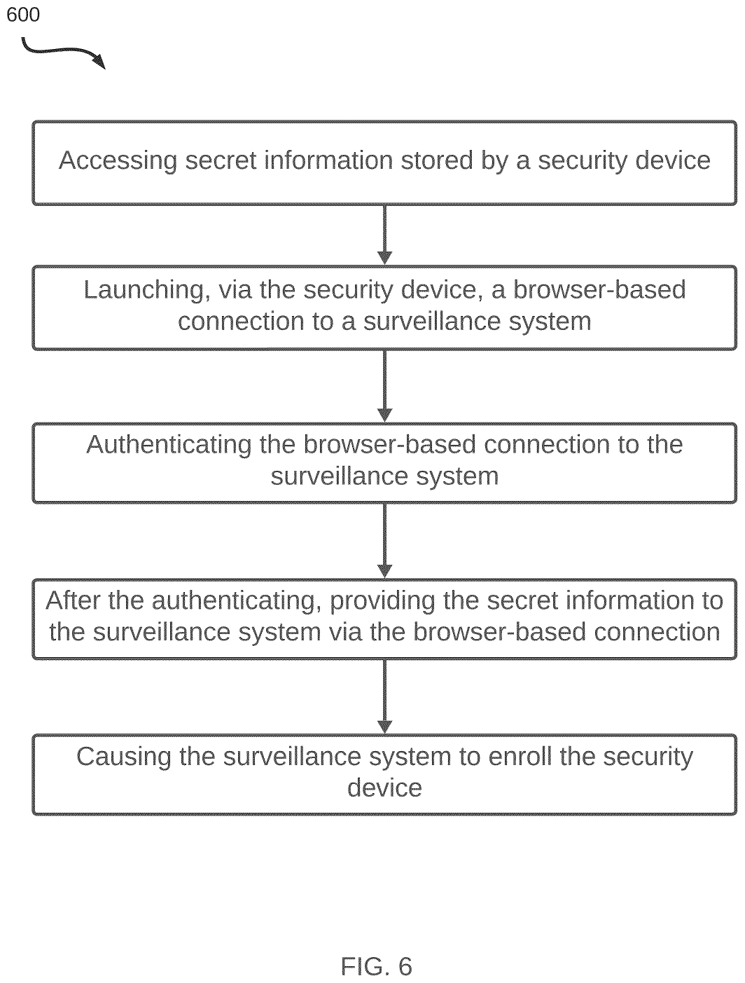

With reference to FIG. 6, there is illustrated another method 600 for enrolling a security device (e.g., the security device 120) with a surveillance system (e.g., with the security device management server 150 of the surveillance system 130). Secret information stored by the security device 120 is accessed, for example by the computing device 110. In some embodiments, the secret information is accessed via a configuration page hosted by the security device 120 (e.g., the configuration page 210).

A browser-based connection to the security device management server 150 is launched via the security device 120, for example within the browser 200 of the computing device 110. The browser-based connection may be launched by interacting with a link or other element of the configuration page 210. In some cases, there may be multiple links associated with different security device management server 150, which may be selectable via input from the computing device 110.

The browser-based connection to the security device management server 150 is authenticated, whether based on a previous authentication for the computing device 110 or based on credentials supplied by the computing device 110. After the authenticating, the secret information is provided to the security device management server 150 via the browser-based connection, for example via a link used to access an enrollment service. In some embodiments, additional information may be provided to the security device management server 150: this may include enrollment information for enrolling the security device 120 with the security device management server 150 and/or configuration information for configuring the operation of the security device 120. In some embodiments, a configuration page hosted by the security device management server 150 may obtain input from the computing device 110 which includes additional enrollment and/or configuration information.

The security device management server 150 then enrolls the security device 120, for instance via the enrollment service. Enrollment of the security device 120 serves, at least in part, to establish the secure connection 105 between the security device management server 150 and the security device. In some embodiments, enrollment of the security device 120 includes communicating information for configuring operation of the security device 120 to the security device 120, whether via the secure connection 105 or via a different connection, for instance one which uses the computing device 110 as an intermediary.

The embodiments of the methods, systems, devices, and computer-readable media described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references have been made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The foregoing discussion provides many example embodiments. Although each embodiment represents a single combination of inventive elements, other examples may include all possible combinations of the disclosed elements. Thus, if one embodiment comprises elements A, B, and C, and a second embodiment comprises elements B and D, other remaining combinations of A, B, C, or D, may also be used.

The terms “connected” or “coupled to”, as well as any similar terms, may include both direct coupling (in which two elements that are coupled to each other contact each other) and indirect coupling (in which at least one additional element is located between the two elements).

The use of numerical ranges by endpoints in the present disclosure should be understood as including all numbers within that range (e.g., 1 to 5 includes 1, 1.25, 2, 2.5, 3, 3.69, 4, 4.33, 5, etc.). Where a range of values is qualified as being “greater than”, “less than”, etc., of a particular value, that value may or may not be included within the range, as appropriate.

Any direction or orientation described in the present disclosure, including but not limited to “top”, “bottom”, “left”, “right”, “upper”, “lower”, “above”, below”, as well as other directions and orientations, are described herein for clarity, and should be understood in reference to the drawings. These and other similar terms should not be understood as limiting of an actual device or system or of use of the device or system. Many of the devices, articles, or systems described in the present disclosure may be used in a number of suitable directions and orientations.

Any citation to references in this disclosure and during the prosecution thereof is made out of an abundance of caution. No citation should be construed as an admission that the cited reference qualifies as prior art or comes from an area that is analogous or directly applicable to the present teachings.

For clarity in interpreting the claims appended hereto, and for avoidance of any misunderstanding, it is noted that none of the appended claims or elements of the appended claims, as pending or as granted, are intended to invoke 35 U.S.C. 112(f) unless the words “means for” or “step for” are explicitly used in the particular claim or claim or claim element.

The technical solution of embodiments may be in the form of a software product. The software product may be stored in a non-volatile or non-transitory computer-readable storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and at least some of the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

Although the embodiments have been described in detail, it should be understood that various changes, substitutions, and alterations can be made herein without departing from the scope as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized. Accordingly, the examples described above and illustrated herein are intended to be examples only, and the appended claims are intended to include within their scope such processes, machines, manufacture, compositions of matter, means, methods, or steps.

Generally, all terms used in the claims are to be interpreted according to their ordinary meaning in the relevant technical field, unless explicitly defined otherwise herein. All references to a/an/the element, apparatus, component, means, step, etc., are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second”, etc. for different features/components of the present disclosure are only intended to distinguish the features/components from other similar features/components and not to impart any order or hierarchy to the features/components.

1. A method for enrolling a camera into a video management system (VMS), the camera and the VMS being connected to a common network, the method comprising:
establishing a first browser-based connection over the network to the camera;
accessing, over the browser-based connection, a configuration page hosted by the camera;
displaying a graphical-user interface (GUI) of the configuration page, the GUI comprising at least one interactive GUI element;
detecting user interaction with an enrollment GUI element of the configuration page;
accessing, responsive to the detecting, secret information stored by the camera, the secret information used for enrolling the camera with the VMS;
obtaining, from the configuration page in response to the user interaction, a link to a configuration site associated with the VMS, the link comprising at least part of the secret information;
launching, using the link, a second browser-based connection to the configuration site;
authenticating the second browser-based connection to the configuration site;
after the authenticating, providing, by the link, the at least part of the secret information to the VMS via the second browser-based connection;
causing the VMS to enroll the camera using the at least part of the secret information comprised in the link; and
displaying an enrollment confirmation obtained from the configuration site over the second browser-based connection in response to the camera being enrolled with the VMS.

2. The method of claim 1, wherein said establishing of the first browser-based connection comprises connecting to the camera via an IP address associated therewith.

3. The method of claim 1, comprising authenticating the first browser-based connection to the camera by supplying access credentials to the camera.

4. The method of claim 3, wherein said authenticating of the first browser-based connection to the camera comprises supplying default access credentials, the method comprising modifying the camera to accept a future browser-based connection using updated access credentials, different from the default access credentials.

5. The method of claim 3, wherein said authenticating of the second browser-based connection to the configuration site comprises supplying the access credentials to the configuration site and/or to the VMS.

6. The method of claim 1, wherein said launching of the second browser-based connection to the VMS comprises launching the second browser-based connection over the Internet.

7. The method of claim 1, wherein said authenticating of the second browser-based connection to the VMS comprises authenticating a user via a single sign-on (SSO) process.

8. The method of claim 1, wherein launching the second browser-based connection comprises selecting, on the configuration site associated with the VMS, one of a plurality of surveillance systems.

9. The method of claim 1, comprising, after the authenticating, providing additional information for use in at least one of enrollment of the camera and configuration of the camera subsequent to enrollment thereof to the VMS via the configuration site.

10. The method of claim 9, wherein said providing of the additional information for the camera to the VMS comprises detecting further user interaction with the configuration site and providing, based on the further user interaction, the additional information.

11. The method of claim 9, wherein said accessing, responsive to the detecting, comprises accessing the additional information stored by the camera.

12. The method of claim 11, wherein said providing of the additional information for the camera to the VMS comprises providing, by the link, the additional information.

13. The method of claim 1, wherein said providing, by the link, of the at least part of the secret information to the VMS comprises providing the secret information in a trailing portion of the link used to launch the browser-based connection.

14. The method of claim 1, wherein enrollment of the camera is effected based on the user interaction with the enrollment GUI element without any additional user input.

15. A system for enrolling a camera into a video management system (VMS), the camera and the VMS being connected to a common network, the system comprising:
a processor; and
a non-transitory computer-readable storage medium comprising instructions executable by the processor for causing the system to perform:
establishing a first browser-based connection over the network to the camera;
accessing, over the browser-based connection, a configuration page hosted by the camera;
displaying a graphical-user interface (GUI) of the configuration page, the GUI comprising at least one interactive GUI element;
detecting user interaction with an enrollment GUI element of the configuration page;
accessing, responsive to the detecting, secret information stored by the camera, the secret information used for enrolling the camera with the VMS;
obtaining, from the configuration page in response to the user interaction, a link to a configuration site associated with the VMS, the link comprising at least part of the secret information;
launching, using the link, a second browser-based connection to the configuration site;
authenticating the second browser-based connection to the configuration site;
after the authenticating, providing, by the link, the at least part of the secret information to the VMS via the second browser-based connection;
causing the VMS to enroll the camera using the at least part of the secret information comprised in the link; and
displaying an enrollment confirmation obtained from the configuration site over the second browser-based connection in response to the camera being enrolled with the VMS.

16. The system of claim 15, wherein, after the authenticating, the instructions are executable for providing additional information for use in at least one of enrollment of the camera and configuration of the camera subsequent to enrollment thereof to the VMS via the configuration site.

17. The system of claim 16, wherein said providing of the additional information for the camera to the VMS comprises detecting further user interaction with the configuration site and providing, based on the further user interaction, the additional information.

18. The system of claim 16, wherein said accessing, responsive to the detecting, comprises accessing the additional information stored by the camera.

19. The system of claim 18, wherein said providing of the additional information for the camera to the VMS comprises providing, by the link, the additional information.

20. The system of claim 15, wherein said providing, by the link, of the at least part of the secret information to the VMS comprises providing the secret information in a trailing portion of the link used to launch the browser-based connection.

21. A method for enrolling a security device into a surveillance system, comprising:
obtaining secret information stored by the security device;
instantiating, via the security device, a browser-based connection to the surveillance system;
authenticating the browser-based connection to the surveillance system;
after the authenticating, providing the secret information to the surveillance system via the browser-based connection; and
causing the surveillance system to enroll the security device.
